(19) United States
(12) Patent Application Publication
(10) Pub. No.: US 2005/0240687 A1
(43) Pub. Date: Oct. 27, 2005

(54) Microcomputer for automotive system

(75) Inventor: Hiroshi Hayakawa, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/108,758

(22) Filed: Apr. 19, 2005

(30) Foreign Application Priority Data
Apr. 23, 2004 (JP) 2004-128356

(51) Int. Cl. G06F 13/12

(52) U.S. Cl. 710/10

(57) ABSTRACT

A power-on reset operation is succeeded by initialization operations of a central processing unit (CPU) and a peripheral circuit in an electric control unit (ECU). The initialization operation controlled by the peripheral circuit proceeds in parallel with the initialization operation of the CPU. A communication session between the ECUs is established in the initialization operations by a communication controller. Parallel execution of the initialization operations contributes to a decrease of initialization time of the ECU and results in a prompt start-up of an automotive system using the ECU.

### CROSS REFERENCE TO RELATED APPLICATION

This application is based on Japanese Patent Application No. 2004-128356 filed on Apr. 23, 2004, the disclosure of which is incorporated herein by reference.

### FIELD OF THE INVENTION

The present invention relates to a microcomputer for an automotive system and, more specifically to a microcomputer for an automotive system having a CPU and a peripheral circuit.

### BACKGROUND OF THE INVENTION

Microcomputers composed of a CPU, a ROM, a RAM, and a circuitry for various functions initialize those devices and circuitry after a CPU power-on reset operation is executed. This CPU power-on reset operation is necessary for automotive systems having microcomputers for those functions because of the fluctuation of electricity after the microcomputers are turned on. Original system functions of the microcomputer and the automotive system using the microcomputer start after this power-on reset operation.

In recent years, various kinds of peripheral circuits for diversified system requirement and a large amount of memory for handling image-related data demand complicated initialization processes programmed in numerous steps of source codes. One-chip type microcomputers having an internal control program have a strict restriction on memory capacity for storing the program in most cases.

In addressing such issues about increased volume of program and restriction on memory capacity, a microcomputer having an automatic peripheral circuit initialization function is proposed in Japanese Patent Document JP-A-2003-173327. In this microcomputer, the initialization operation for a peripheral circuit is executed automatically as an autonomic function of the peripheral circuit in parallel with a CPU power-on reset operation. That is, no instruction from a CPU to the peripheral circuit is required.

However, in this scheme of initialization operation for a CPU and a peripheral circuit, total initialization time cannot be reduced even when volume of initialization program is decreased as shown in FIGS. 6B and 6C. That is, initialization operation totally under control of a CPU shown in FIG. 6B, and initialization operation partially under control of automatic peripheral circuit shown in FIG. 6C have eventually the same amount of total initialization time. Change in the initialization operation order is not effective for decreasing initialization time.

Automotive systems typically use plural microcomputers (ECUs) connected through communication network (automotive LAN) for exchanging data and organizing ECUs and devices. Further, the automotive systems have hierarchy of initialization operations, that is, initialization of a total system by establishing communication between ECUs after initialization of each ECU. This is another cause for an extended initialization time before starting automotive systems having microcomputers.

### SUMMARY OF THE INVENTION

In view of the above-described problems, it is an object of the present invention to provide a microcomputer for automotive systems having reduced initialization time after a CPU reset operation.

Peripheral circuits in a microcomputer in the present invention automatically execute initialization operation by themselves, that is, by using an initialization means, without having instruction from the CPU when the CPU reset operation completes. The CPU reset operation and peripheral circuit reset operation complete simultaneously when the microcomputer is started.

In this manner, a CPU initialization operation based on a program and an automatic peripheral circuit initialization operation by the initialization means without having instruction from the CPU are executed in parallel when the reset operations for the CPU and for the peripheral circuit complete.

As a result, a total initialization operation of the microcomputer is decreased by the amount of a shorter initialization operation as shown in FIG. 6A. Therefore, a main operation of the microcomputer can be started promptly.

In addition, the microcomputer of the present invention uses the same initialization signal for both of CPU initialization and for peripheral circuit initialization. This simplifies the structure of the microcomputer and leads to a decreased initialization time.

Further, if the peripheral circuits are under control of a register that stores CPU instructions for the peripheral circuits, the automatic initialization operation of the peripheral circuits may be controlled by instructions that are at least partially created by the initialization means and stored in the register.

Further, if the initialization means controls automatic initialization operations for plural peripheral circuits, the automatic initialization operations for the plural peripheral circuits may preferably be executed in parallel rather than in order.

Further, if the initialization means controls an automatic initialization process for a communication controller that controls communication between the microcomputers, the initialization means may preferably control not only the initialization of the communication controller but also establishment of a communication session between the microcomputers through the communication controller.

In this manner, the CPU can promptly start a cooperation process with another microcomputer after the automatic initialization process controlled by the initialization means because of the established communication between the microcomputers.

Further, if the communication controller is equipped with an encrypted communication function, a session key for encryption and decryption has to be exchanged by the microcomputers participating in an encrypted communication. Therefore, when the session key exchange operation has been executed by the initialization means in parallel with the initialization of other part of the microcomputer, the CPU can promptly start a cooperation process with other microcomputers.

The microcomputer of the present invention may preferably be controlled by an instruction stored in a data storage means of a non-volatile memory. The instruction for initialization may be created by the initialization means. In this case, a power-off control means may preferably create data for the next initialization operation and store the data in the data storage means before shutting down the microcomputer in a power-off process. In this manner, the microcomputer can promptly start a main process because preparation for the initialization data is saved when the microcomputer starts next time.

Further, if the initialization means controls an automatic initialization process for a communication controller that controls the encrypted communication between the microcomputers, the initialization means may preferably execute a session key exchange operation that distributes a session key for encryption and decryption to the participating microcomputers.

The microcomputer of the present invention may preferably be used in an electric device controller of the automotive system. Plural electric device controllers of the automotive system communicate each other through the automotive network. In this case, the initialization process of each electric device controller and establishment of communication between the electric device controllers are executed in parallel. Therefore, the total initialization time of the automotive system can be greatly reduced.

### BRIEF DESCRIPTION OF THE DRAWINGS

Other objects, features and advantages of the present invention will become more apparent from the following detailed description made with reference to the accompanying drawings, in which:

FIG. 1 is a block diagram illustrating a structure of an automotive system of the present invention;

FIG. 2 is a block diagram of a communication controller according to a first embodiment;

FIG. 3 is a time chart illustrating an arrangement of processes executed in ECUs after power-on reset operation;

FIG. 4 is a block diagram of a communication controller according to a second embodiment;

FIG. 5 is a time chart illustrating processes executed in ECUs after power-off instruction;

FIG. 6A is a time chart illustrating initialization processes executed in a CPU and a peripheral circuit according to the present invention;

FIG. 6B is a time chart illustrating initialization processes executed in a CPU of a conventional system; and

FIG. 6C is a time chart illustrating initialization processes executed in a CPU and an I/O device of a conventional system.

### DETAILED DESCRIPTION OF THE PREFERRED EMBODIMENTS

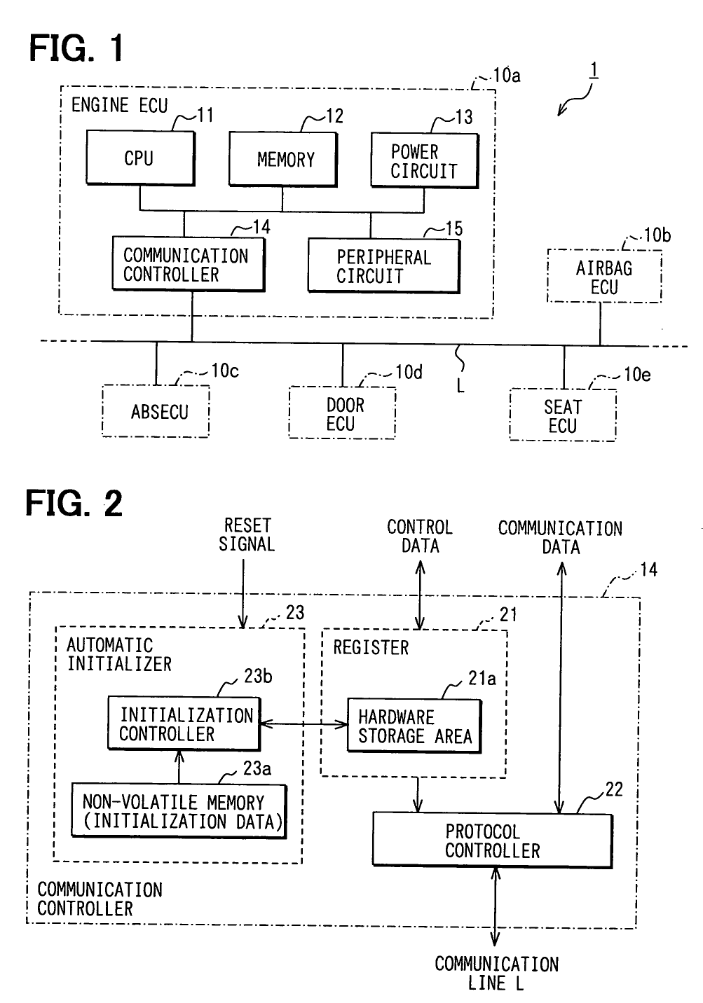

An automotive system 1 in a first embodiment includes plural electric control units 10 for different automotive control functions as shown in FIG. 1. Electric control units 10 include, in this case, an engine ECU 10a, an airbag ECU 10b, an ABSECU 10c, a door ECU, a seat ECU and the like. These ECUs 10 are interconnected with each other through a communication line L, and make up a so-called automotive LAN.

Each ECU 10 has a similar structure that includes a CPU 11, a memory 12, a power circuit 13, a communication controller 14 and a peripheral circuit 15. In each ECU 10, a program stored in the memory 12 uses the CPU 11 for processing data stored in the memory 12 and received from other ECU 10 through the communication controller 14. In this manner, each ECU 10 is associated with other ECUs 10 to implement a required function.

The power circuit 13 (not shown in the figure) supplies electricity to each part of the ECU 10 when an ignition switch is turned on. The power circuit 13 keeps reset state of each part by controlling a reset signal until voltage of the electricity to each part rises to a predetermined level that assures normal operation. The reset signal is provided to the CPU 11, the communication controller 14 and the peripheral circuit 15 simultaneously.

The communication controller 14, as shown in FIG. 2, includes a register 21 for storing initialization data and control data (command), a protocol controller 22 for controlling communication based on the contents of the register 21 and an automatic initializer 23 that initializes the register 21 automatically after a power-on reset by the reset signal ends.

The CPU 11 controls data stored in the register 21. Further the automatic initializer 23 controls data stored in a part of the register 21, that is, a hardware storage area 21a.

The automatic initializer 23 includes a non-volatile memory 23a for storing various kinds of initialization data for the communication controller 14 and an initialization controller 23b for controlling a series of operations that retrieve data orderly from the memory 23a and store the data in the hardware storage area 21a.

More practically, the non-volatile memory 23a at least stores initialization data for specified operations of the protocol controller 22 such as a baud rate, a data length and the like, and a command for controlling the protocol controller 22 in order to establish a communication session with another ECU 10. The initialization controller 23b initializes the communication controller 14 by storing initialization data in the register 21, and stores the command to give instructions for establishing a communication session.

That is, the communication controller 14 is automatically initialized by the initialization controller 23b to be in a session-ready condition without having instruction from the CPU 11. The session-ready condition means, in this case, a condition in which a communication session for sending and receiving data is established. Required time for initializing the communication controller 14 in each ECU 10 is substantially the same.

The CPU 11 controls initialization of the memory 12 (more specifically, the RAM), and the peripheral circuit 15, and exchanges data through the communication controller 14 to associate other ECUs for performing an assigned function to the CPU 11 itself. Required time for initialization by the CPU 11 differs in each ECU because it depends on the capacity of memory 12 and the peripheral circuit 15.

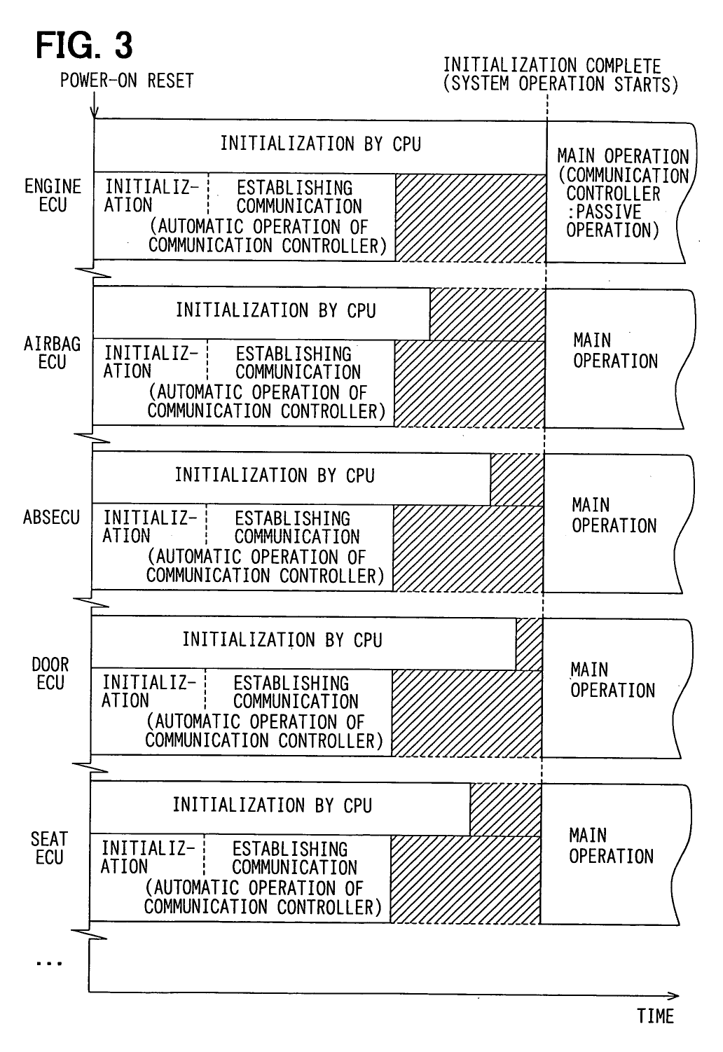

In this manner, initialization operation under instruction from the CPU 11, and the automatic initialization process and establishment of the communication session controlled by the communication controller 14 are executed in parallel in the ECU 10, as shown in FIG. 3, after the ignition switch is turned on and the power-on reset by the power circuit 13 ends.

A main part of system operation in the automotive system 1 can be started when operation of the initialization by the CPU 11 in each ECU 10, and operation of the automatic initialization and establishment of communication session by the communication controller 14 are completed. In FIG. 3, the initialization of the engine ECU 10a by the CPU 11 ends last.

The automotive system 1 of the present embodiment, as described above, executes initialization of each CPU 11 in the ECUs 10 and automatic initialization of the communication controller 14 in parallel. Therefore, initialization of the ECUs 10 and initialization of the automotive system end in a decreased period of time, and system operation can be started promptly.

In addition, establishment of the communication session as well as the initialization of the communication controller 14 is executed automatically in this embodiment. As a result, the CPU 11 can promptly start communication with other ECUs 10 after initialization.

(Second Embodiment)

In a second embodiment of the present invention, a structure of the controller 14 is partially changed from the one in the first embodiment. The description is focused on this changed part.

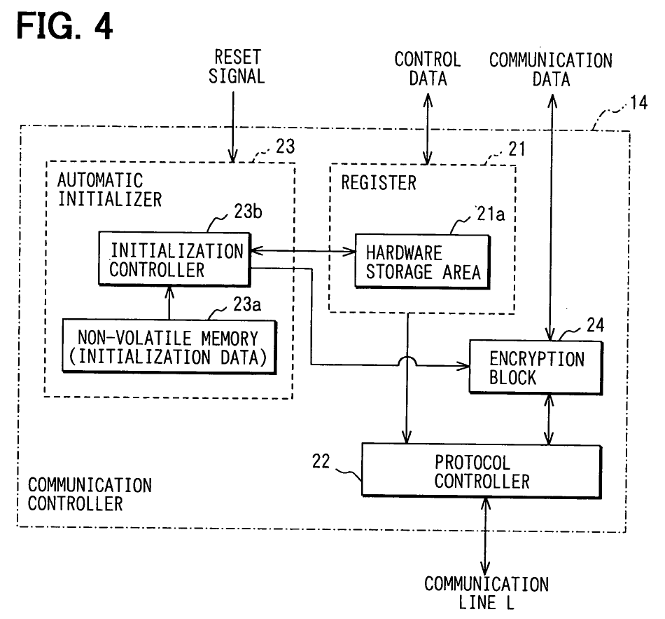

T+he communication controller 14, as shown in FIG. 4, includes an encryption block 24 for encryption and decryption of the data sent and received through the protocol controller 22.

The initialization controller 23b executes a session key exchange operation for establishing an encrypted communication with another ECU 10 beside the processes described in the first embodiment.

The session key exchange process is based on a third party authentication process such as SSL (Secure Socket Layer), Kerberos or the like. Description of these techniques is omitted because those are well-known technologies.

(Third Embodiment)

In a third embodiment of the present invention, operation of the power circuit 13 and the communication controller 14 is partially different from the operation of the same parts in the second embodiment.

In the third embodiment, the power circuit 13 outputs power-off instruction to the communication controller 14 when it detects the ignition switch is turned off. The power circuit 13 waits a predetermined time for allowing the communication controller 14 to complete the session key exchange operation before stopping supply of electricity for various parts in the ECU 10.

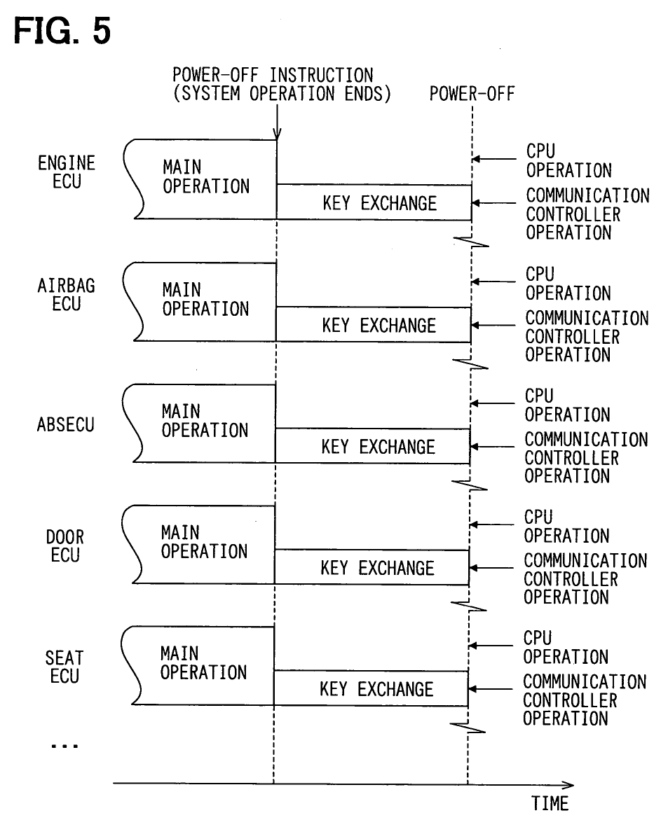

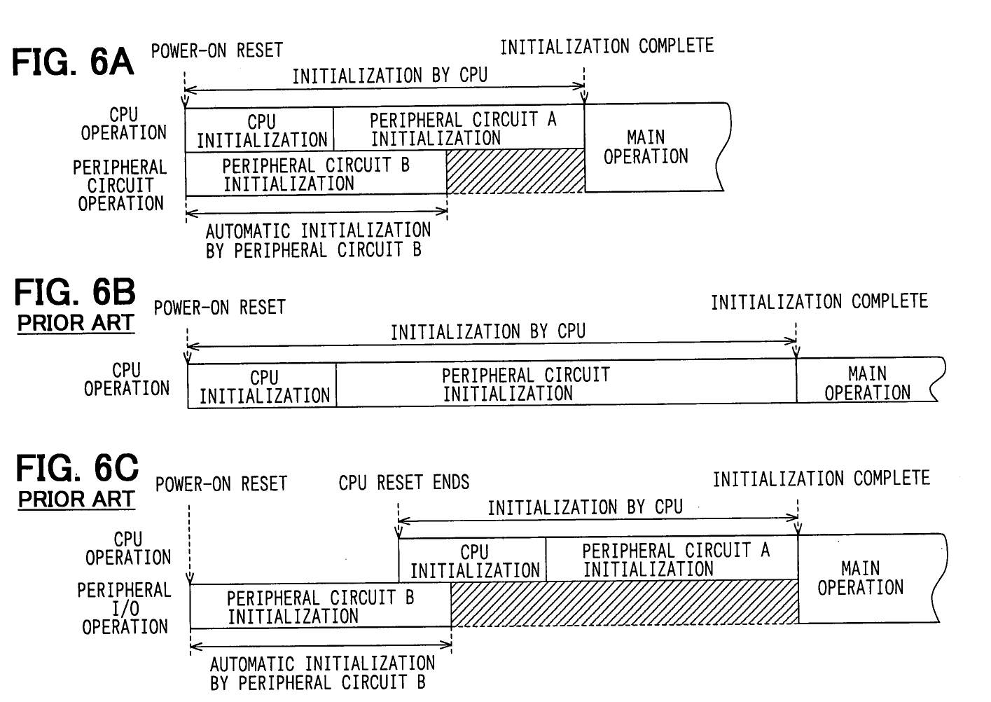

The initialization controller 23b in the communication controller 14, as shown in FIG. 5, does not exchange the session key in the initialization process after the power-on reset, but exchanges the session key automatically without having instruction from the CPU 11 upon receiving the power-off instruction from the power circuit 13.

That is, the ECU 10 does not stop operation promptly after the ignition switch is turned off, but creates the session key for the next initialization and exchanges it with another ECU for the encrypted communication.

Therefore, the automotive system 1 in the present embodiment can start the system operation more promptly compared to the second embodiment because of the pre-exchanged session key used in the initialization operation.

In addition, the power circuit 13 may stop supply of electricity when it receives a message that notifies completion of the key exchange operation sent from the communication controller 14 instead of stopping supply of electricity after a predetermined period of time.

Though the communication controller 14 automatically exchanges the session key in the present embodiment, the CPU 11 may make the communication controller 14 exchange the session key.

Such changes and modifications are to be understood as being within the scope of the present invention as defined by the appended claims.

1. A microcomputer for a promptness of an automotive system comprising:
a CPU; and
a peripheral circuit including an initialization means for initializing the peripheral circuit without movement directive from the CPU after the microcomputer performs a reset operation, wherein
the reset operation includes a reset operation for the CPU and a reset operation for the peripheral circuit that end substantially concurrently with the initialization being started.

2. The microcomputer of claim 1,
wherein the peripheral circuit includes a register for holding data under instruction from the CPU,
wherein the data held in the register controls the peripheral circuit, and
wherein the data in the register is at least partially prepared by the initialization means.

3. The microcomputer of claim 1,
wherein the peripheral circuit includes a communication controller for controlling communication with a second microcomputer, and
wherein the initialization means controls initialization of the communication controller and establishment of a communication session with the second microcomputer through the communication controller.

4. The microcomputer of claim 3,
wherein the communication controller controls an encrypted communication with the second microcomputer, and
wherein the initialization means exchanges a session key used for encryption and decryption in the encrypted communication when the encrypted communication is established.

5. The microcomputer of claim 1 further comprising:
a data storage means implemented as a non-volatile memory for storing initialization data used by the initialization means; and
a power-off control means for preparing the initialization data for a subsequent initialization operation in the data storage means in a power-off operation of the microcomputer when the power-off operation is instructed.

6. A microcomputer having a CPU and a peripheral circuit that prepares initialization data in a power-off operation for a subsequent initialization comprising:
a data storage means implemented as a non-volatile memory for storing the initialization data of the peripheral circuit;
an initialization means for initializing the peripheral circuit after performing a reset operation by using the initialization data in the data storage means automatically without movement directive from the CPU; and
a power-off control means for storing the initialization data for the subsequent initialization in the data storage means in the power-off operation.

7. The microcomputer of claim 6,
wherein the peripheral circuit includes a communication controller for controlling an encrypted communication with a second microcomputer, and
wherein the initialization means exchanges a session key for encryption and decryption in the encrypted communication with the second microcomputer during the initialization.

8. The microcomputer of claim 3,
wherein the microcomputer is used in an electric control unit, and
wherein the electric control unit intercommunicates with other electric control units through a communication network in an automobile to organize an automotive system.

9. A method performed by a microcomputer for an initialization of a CPU and a peripheral circuit comprising the steps of:
resetting the CPU and the peripheral circuit when the microcomputer is turned on;
initializing the CPU and the peripheral circuit substantially simultaneously with each other subsequent to the resetting; and
preparing initialization data for use in a subsequent initializing process of the peripheral circuit while the microcomputer is turning off.

10. The method of claim 9,
wherein the step of preparing initialization data includes the steps of creating the initialization data for the subsequent initialization, and storing the initialization data in a data storage means.
